(19) United States
(12) Patent Application Publication
(10) Pub. No.: US 2024/0403057 A1
(43) Pub. Date: Dec. 5, 2024

(54) PROFILING SYSTEM AND METHODS

(71) Applicants: Norwegian University of Science and Technology (NTNU), Trondheim (NO); Universiteit Gent, Gent (BE)

(72) Inventors: Magnus Jahre, Trondheim (NO); Björn Gottschall, Trondheim (NO); Lieven Eeckhout, Evergem (BE)

(21) Appl. No.: 18/733,006

(22) Filed: Jun. 4, 2024

(30) Foreign Application Priority Data
Jun. 5, 2023 (GB) 2308369.4

(51) Int. Cl. G06F 9/38; G06F 11/34

(52) U.S. Cl. CPC G06F 9/3836; G06F 11/3466

(57) ABSTRACT

A processing system has a processor and profiling circuitry. The processor is configured to commit instructions in a program order, and comprises circuitry for determining and storing performance-event data for each instruction committed by the processor. The performance-event data for each instruction indicates whether the instruction experiences any of a predetermined set of one or more performance events. The profiling circuitry generates sample data at intervals, and writes the sample data to a sample register or memory. The sample data generated at each interval identifies one or more instructions that are next-to-be committed by the processor or one or more instructions that were last committed by the processor, and comprises the respective performance-event data for each of the identified instructions.

### CROSS-REFERENCE TO RELATED APPLICATION(S)

This application claims priority to United Kingdom Patent Application No. 2308369.4 filed on Jun. 5, 2023, wherein the entire contents of the foregoing application are hereby incorporated by reference herein.

### TECHNICAL FIELD

This invention relates to processing systems and methods for profiling instructions committed by a processor.

### BACKGROUND OF THE INVENTION

As computer architectures become increasingly complex and heterogeneous, it becomes progressively more difficult to write software that makes good use of hardware resources. It can be useful for software developers to be able to determine which parts of a software program cause performance losses. Instruction-level software profiling tools can allow a developer to determine this down to the level of individual processor instructions.

To support instruction-level profiling, a processor may have associated profiling circuitry, comprising hardware logic for sampling a currently-processing instruction. By sampling at regular intervals, as a program runs, and counting how often each instruction appears in the collected sample data, it can be statistically determined how much time the processor is spending processing particular instructions.

It can also be beneficial for software developers to determine why certain instructions take a long time to process. This can be determined by identifying what, if any, negative microarchitectural performance events occur during the processing of a particular instruction. These events could be an instruction cache miss, a data cache miss, or a mis-predicted branch, etc.

Embodiments of the present invention seek to provide profiling circuitry and methods that support more accurate software-program profiling on processors that can identify the performance events which occur when processing an instruction. This can be applied to processors which include, but are but not limited to, processors that execute instructions out of program order.

### SUMMARY OF THE INVENTION

From a first aspect, the invention provides a processing system comprising:
a processor; and
profiling circuitry,
wherein the processor is configured to commit instructions in a program order, and comprises circuitry for determining and storing performance-event data for each instruction committed by the processor, wherein the performance-event data for each instruction indicates whether the instruction experiences any of a predetermined set of one or more performance events; and
wherein the profiling circuitry is configured to generate sample data at intervals, and to write the sample data to a sample register or memory, wherein the sample data generated at each interval identifies one or more instructions that are next-to-be committed by the processor or one or more instructions that were last committed by the processor, and comprises the respective performance-event data for each of the identified instructions.

From a further aspect, the invention provides a method for profiling instructions committed by a processor, the method comprising:
determining and storing performance-event data for each instruction committed by a processor, wherein the performance-event data for each instruction indicates whether the instruction experiences any of a predetermined set of one or more performance events; and
generating sample data at intervals, and writing the sample data to a sample register or memory, wherein the sample data generated at each interval identifies one or more instructions that are next-to-be committed by the processor or one or more instructions that were last committed by the processor, and comprises the respective performance-event data for each of the identified instructions.

Thus it will be seen that, in accordance with embodiments of the invention, by storing performance-event data for every instruction committed by the processor, any arbitrary instruction can be sampled, at any stage of the processor pipeline, and performance-event data can be stored for that instruction. In particular, instructions can be sampled, and associated performance-event data output for storage, at the commit stage of the processor pipeline. This contrasts with prior approaches in which performance-event data is stored only for selected instructions that are tagged for sampling, in advance, in the front-end of the processor (e.g. at the fetch or dispatch stages of the processor pipeline). By being configured to identify the next-committing instruction(s) or the last-committed instruction, and to retrieve performance-event data associated with each sampled instruction, profiling circuitry as disclosed herein can enable more accurate profiles to be created of software executed on the processor. This is explained in greater detail below. In particular, more accurate indications can be generated of which instructions are incurring the most processing time, as well as what performance events (i.e. what types of performance event) are causing the processor to spend additional time processing these instructions. This performance profiling information can be advantageously used to inform the development of more efficient software programs.

The processor may be configured to process instructions using a pipeline having at least a fetch stage, a dispatch stage and a commit stage. It may process instructions using one or a plurality of pipelines. It may be a scalar or superscalar processor. The processor may support execution of instructions out of program order and may comprise a reorder buffer (ROB). However, this is not essential and, in other embodiments, the processor is configured always to execute instructions in program order.

The performance events in the predetermined set may be respective micro-architectural events (i.e. respective types of micro-architectural event) that occur in the pipeline of the processor and slow down the running of the processor. The performance events may comprise, for example, cache misses and mis-predicted branches.

The processor may comprise a front-end and a back-end. In some embodiments, the predetermined set of one or more performance events comprises one or more events that occur in the front-end of the processor, e.g. at a fetch stage and/or at a dispatch stage. The predetermined set of performance events may comprise one or more events that occur in the back-end of the processor, i.e. after a dispatch stage. In some embodiments, the predetermined set of one or more performance events comprises at least one event (i.e. type of event) that occurs in the front-end of the processor and at least one event (i.e. type of event) that occurs in the back-end of the processor.

The performance-event data may indicate that an instruction has experienced a plurality of different performance events at two or more different respective stages of the processing of the instruction by the processor.

In some embodiments, the predetermined set of one or more performance events comprises any one or more, or all, of the following performance events: an instruction cache miss, an instruction translation look-aside buffer (TLB) miss, a store instruction stalled at dispatch, a mis-predicted branch, an instruction caused exception, a memory ordering violation, a data cache miss, a data TLB miss, and a last-level cache (LLC) miss caused by a load instruction. In some embodiments, the set of performance events consists of all of these performance events and no other performance events.

In other embodiments, the set of performance events may comprise any subset of one or more of these performance events. In some embodiments, the set of performance events may comprise one or more performance events not included in this list, optionally in combination with any one or more, or all, performance events from this list.

In some embodiments, the performance-event data for each instruction comprises a performance-event vector, wherein the vector comprises one or more bits of information, and each bit in the vector indicates whether the instruction has experienced a different respective performance event from the predetermined set of performance events.

The processor may be configured for executing a software program that comprises one or more static instructions. The processor may be configured to decode each static instruction into one or more dynamic instructions. Each dynamic instruction may be a respective micro-operation. Each dynamic instruction may be dispatched and committed separately by the processor.

Some processors may support the generating of fused micro-operations. Thus, in some embodiments, the processor may be configured to generate a dynamic instruction (e.g. a fused micro-operation) by combining one or more micro-operations associated with a first static instruction with one or more micro-operations associated with a second static instruction. Such a dynamic instruction may therefore be associated with two or more static instructions.

Each instruction committed by the processor may be a respective dynamic instruction (e.g. a respective micro-operation), wherein each dynamic instruction is associated with (i.e. derived from) one or more static instructions in a software program being executed by the processor.

Performance-event data may be determined for each dynamic instruction. Performance-event data may further be stored for each dynamic instruction. Associated metadata may further be stored for each dynamic instruction, wherein the metadata comprises the address of the static instruction or instructions with which the micro-instruction is associated. Thus, in particular, the sample data generated at each interval may identify the static instruction(s) associated with the dynamic instruction(s) that are next-to-be committed or that were last committed. The sample data may identify the static instruction(s) in any appropriate way. It may comprise a memory address of each identified instruction. Thus, in some embodiments, for each dynamic instruction committed by the processor, the processor is configured to store data identifying one or more respective static instruction(s) with which the dynamic instruction is associated (i.e. from which it was derived) and performance-event data indicating whether the dynamic instruction experiences any of the predetermined set of one or more performance events.

The processor may be configured to store both the data identifying the static instructions and the associated performance-event data in one or more dedicated portions of memory in the profiling circuitry. However, in some embodiments, the performance-event data for each instruction committed by the processor, and the data identifying the respective static instruction(s) with which the instruction committed by the processor is associated may be stored in commit-information circuitry, which may be a reorder buffer (e.g. in embodiments in which the processor supports execution of instructions out of program order). Alternatively, the commit-information circuitry may be a scoreboard (e.g. in embodiments in which the processor always executes instructions in program order), or other appropriate circuitry such as hazard detection logic (e.g. in embodiments in which the processor has a multi-stage pipelined architecture).

In some embodiments, the intervals at which the profiling circuitry is configured to generate sample data (i.e. the sample intervals) are regular intervals. In other embodiments, the intervals may be irregular (e.g. pseudorandom). Respective sample data may be associated with respective sample instants, which may correspond to different respective processor clock cycles. In some embodiments, the profiling circuitry may generate sample data at every processor clock cycle, although it may output the sample data less often than this. In such embodiments, software (e.g. profiling software executing on the processor or a further processor) or other circuitry (e.g. a performance management unit (PMU)) may read all or a fraction of the sample data; for example, it may fetch, at regular or irregular collection intervals, the latest sample data stored in the sample register or memory.

In some embodiments, the profiling circuitry may comprise sampling circuitry. In such embodiments, the sampling circuitry may be configured to write sample data to the sample register or memory (i.e. to generate a sample) in response to an internal event timer within the sampling circuitry, but in a preferred set of embodiments it is configured to do so in response to receiving a command from outside the sampling circuitry—e.g. from a PMU.

In some embodiments, the sampling circuitry may output the sample data directly to a volatile or non-volatile memory (e.g. RAM) at every sample instant. The processing system may comprise a memory (e.g. RAM), to which the sampling circuitry may write the sample data. However, in other embodiments, the profiling circuitry comprises a sample register (i.e. comprising a plurality of flip-flops), to which the sampling circuitry outputs the sample data (at least initially) at every sample instant. The sample register may be sized for storing data identifying a plurality of instructions and the respective performance-event data for each of the identified instructions—e.g. for storing a plurality of static-instruction memory addresses and performance-event vectors. The sample register or memory may be implemented in any appropriate way, and may be split across multiple distinct regions or locations.

The profiling circuitry (or the processing system more widely) may comprise a performance monitoring unit (PMU), which may be arranged to collect some or all of the sample data from the sample register at regular or irregular sampling intervals. It may write the collected sample data to a volatile or non-volatile memory (e.g. RAM or hard-drive). The sampling intervals may correspond to a sampling rate that is lower than an output rate at which the profiling circuitry updates the sample register. Alternatively, the profiling circuitry may be controlled to output the sample data to the sample register at the same rate as the PMU collects the sample data. The sampling circuitry may be configured to inform the PMU that new sample data has been written to the sample register. The PMU may be configured to trigger an interrupt of the processor after collecting the sample data. The interrupt may invoke an interrupt handler in profiling software stored in a memory of the processing system.

More generally, the processing system may comprise a memory storing profiling software. The profiling software may comprise instructions for processing at least some of the sample data to generate either or both of an instruction-level profile and a performance-event-level profile of a software program executed by the processor. The profiling software may comprise further instructions for processing at least some of the sample data to generate time-proportional Per-Instruction Cycle Stacks (PICS), in which the time the architecture spends executing the dynamic instruction(s) associated with each static instruction is broken down into the combinations of, or individual performance events encountered during program execution. These performance profiles may helpfully be used by a software developer to gain insight into which static instructions written in a program are performance-critical, and why they are performance critical, by identifying the most common underlying performance events which lead to the latency.

The profiling software may be executed by the same processor (although it could be executed by a different processor of the processing system in some embodiments).

The profiling software may comprise instructions for analysing a software application executed by the processor. The analysis may be later used to inform the development of a software program such that latency of the program is reduced.

The profiling software may comprise instructions for determining count values for instructions of the software. It may comprise instructions to increment a count value for an instruction when that instruction is identified in the sample data generated by the profiling circuitry, and sampled by the PMU. It may comprise instructions to increment count values for one or more instructions by equal amounts (e.g. equal fractional amounts when there are a plurality of instructions) when the instructions are identified by the sample data for a common clock cycle and the processor is in a computing state.

The profiling software may comprise instructions for determining respective sets of performance-event count values for each instruction of the software. Each set of performance-event count values may comprise a respective performance-event count value for each performance event in the predetermined set of one or more performance events. Each set of performance-event count values may further comprise a performance-event count value for one or more combinations of two or more performance events from the predetermined set. The profiling software may comprise instructions to, for each instruction identified by the sample data and sampled by the PMU, increment a performance-event count value for the instruction when the performance-event data indicates that the instruction has experienced the corresponding performance-event, or combination of performance events.

In some embodiments, the processor further comprises state-determining circuitry configured to access information stored by the processor for committing instructions in program order, and to use the information to determine a commit state of the processor; and the profiling circuitry is configured, when the processor is in a first commit state, to generate sample data that identifies one or more instructions that are next to be committed by the processor, and, when the processor is in a second commit state, to generate sample data that identifies an instruction that was last committed by the processor.

The information stored (and used) by the processor for committing instructions in program order may be stored in commit-information circuitry, which may be a reorder buffer (e.g. in embodiments in which the processor supports execution of instructions out of program order), or a scoreboard (e.g. in embodiments in which the processor always executes instructions in program order), or other appropriate circuitry such as hazard detection logic (e.g. in embodiments in which the processor has a multi-stage pipelined architecture).

The state-determining circuitry is preferably configured to determine when a reorder buffer or pipeline of the processor has been flushed (e.g. due to a branch misprediction or to handle an exception). It may be configured to determine this from a state of the reorder buffer or pipeline—e.g. from one or more flush bits associated with each reorder buffer entry. This approach is compatible with existing processors, since even processors that flush wrong-path instructions immediately upon discovering that a branch is mis-predicted typically include a flush bit in the reorder buffer to implement instructions that always flush (e.g. fence instructions).

The state-determining circuitry may be configured to determine which of the following four states the processor is in: computing, stalled, drained or flushed. It may be configured to signal the state to the sampling circuitry and/or to include state data encoding the state in the sample data.

The first commit state may be or include that a reorder buffer or pipeline of the processor contains one or more instructions (e.g. with the processor actively computing or stalled). It may be or include that a reorder buffer or pipeline of the processor has drained (e.g. due to an instruction cache miss or an instruction Translation Lookaside Buffer (TLB) miss). The first commit state may be or include both of these situations—i.e. when a reorder buffer or pipeline contains one or more instructions or has drained. However, the first commit state preferably excludes the reorder buffer or pipeline being in a flushed state. Thus, the first commit state may comprise the computing state, the stalled state and the drained state.

The second commit state may be that the reorder buffer or pipeline has been flushed (e.g. due to a branch misprediction or an exception). Thus, the second commit state may be the flushed state. By identifying the last-committed instruction in such a situation, the sample data identifies the instruction that caused the misprediction (i.e. the branch instruction that was mis-predicted), thus allowing a statistical profile to more accurately assign clock cycles to the instructions that are the cause of processing delays. This may be useful for accurate profiling not just on out-or-order processors, but also on in-order processors, as it can allow profiling software to take account of the fact that some in-order processors sometimes flush the pipeline in response to an instruction being committed.

In some embodiments, the profiling circuitry may be configured, when the processor is in the first commit state, to generate sample data that does not identify the last-committed instruction (i.e. that only identifies the one or more or all instructions that are next to be committed by the processor). It may be configured, when the processor is in a second commit state, to generate sample data that does not identify any next-committing instruction (i.e. that only identifies the instruction that was last committed by the processor).

However, in other embodiments, the profiling circuitry may be configured to output sample data, associated with a common output instant or processor clock cycle, that identifies one or more instructions that are next to be committed by the processor and that also identifies an instruction that was last committed by the processor. In this case, profiling software may use state data output by the state-determining circuitry to discard instructions that are not relevant and to attribute a sample count only to one or more NCIs or only to the LCI, depending on the state data.

The profiling circuitry may be configured to generate state data that is representative of the commit state of the processor, and to write the state data to the sample register or memory. In this way, a performance monitoring unit (PMU) and/or profiling software may subsequently determine the commit state of the processor by examining the state data. The state data may be generated at intervals, and in some embodiments these intervals may be the same as the intervals at which sample data is generated. The state data may be generated at the same sample instants as the sample data is generated, i.e. for the same processor clock cycles.

Profiling software may use the state data to determine whether to count only one next-committing instruction (e.g. only the oldest such instruction), or every next-committing instruction, or the last-committed instruction, identified in the sample data associated with the sample instant, when generating a statistical profile across a plurality of sample events. However, in other embodiments, profiling software may only receive identification of either the NCI(s) or LCI (but not both), at each output event, depending on the processor commit state.

In some preferred embodiments, the profiling circuitry is configured—at least in some situations, such as when the processor is in a computing state (e.g. not stalled) and will commit a plurality of instructions at the next commit cycle—to identify a plurality of instructions that are next to be committed by the processor in the next commit cycle (i.e. in a common processor clock cycle). The sample data may identify all of the plurality of next-committing instructions. The sample data may identify every next-committing instruction for the common clock cycle. In accordance with the invention described herein, the sample data comprises respective performance-event data for each of the identified instructions.

This contrasts with a naïve approach in which only at most a single instruction, from the head of a reorder buffer, is identified, with any other instructions that will be committed simultaneously (i.e. by a superscalar processor) not being counted. This can lead to a biased profile resulting in inaccurate insights into which instructions are consuming most clock cycles. By identifying multiple next-committing instructions, embodiments can enable profiling software to generate more accurate profiles using the output data, e.g. by assigning an equal fractional clock-cycle count to each next-committing instruction, at least when the processor is in a computing state.

Thus, in some embodiments, the profiling circuitry is configured, when the processor is in a computing state (or in a drained state, for some embodiments) and will commit a plurality of instructions in the next commit cycle, to store sample data in the sample register or memory that identifies the plurality of instructions that are to be committed by the processor in the next commit cycle, and comprises respective performance-event data for each of the identified instructions. This enables profiling software to assign count values to each of these instructions and the performance-events which the performance-event data indicates the occurrence of. In particular, profiling software may assign positive sample counts to all of the NCIs when in the computing state. While it could also do so for the drained state, in preferred embodiments, profiling software attributes a sample count only to the single oldest (i.e. first-committing) instruction when there is the plurality of NCIs. When the processor is in a computing state or drained state and has only a single instruction to commit next, the profiling circuitry may store sample data identifying the next-committing instruction.

The profiling circuitry may further be configured, when the processor is in a stalled state, to store sample data in the sample register or memory that identifies a single instruction that is next to be committed by the processor. The enables profiling software to assign a count value just to this one instruction. At least when stalled, this may be the oldest instruction in the reorder buffer or pipeline—i.e. the instruction at the head of the reorder buffer or pipeline. (In some embodiments, in which the processor comprises a plurality of reorder buffer banks, the sampling data may identify a plurality of instructions, e.g. one instruction from each bank, but then additionally comprising data indicating which one of these instructions is the oldest instruction.) In the drained state, it is possible the next-committing instruction might not yet be in the reorder buffer or pipeline.

In such embodiments, the profiling circuitry will be configured, when the processor is in a flushed state, to store sample data in the sample register or memory that identifies an instruction that was last committed by the processor.

The sampling circuitry may be configured to output sample data that identifies which is an oldest of a plurality of next-committing instructions identified in the sample data. The processor may have a reorder buffer comprising a plurality of banks (e.g. if the processor is a Berkeley Out-of-Order Machine processor), and the profiling circuitry may be configured to access a pointer to the head bank and a pointer to the head column and to use these pointers to determine the oldest next-committing instruction. This may be used for accurately allocating clock cycles when the processor is in a stalled state.

The profiling circuitry may be configured to generate sample data that identifies which is a youngest of a plurality of next-committing instructions identified in the sample data. This may be used for accurately allocating clock cycles when the reorder buffer or pipeline is in a flushed state. It may store the address of the youngest such instruction, along with the performance-event data associated with it, in a register, (e.g. an “offending-instruction register”), which it may update on every processor clock cycle, and may copy the address and performance-event data from the offending-instruction register to the sample register or memory, e.g. in response to detecting there is no valid instruction at the head of the reorder buffer and/or that the processor is in the flushed state.

The profiling circuitry may be configured to generate a stalled signal, and to write the stalled signal to the sample register or memory, for a processor clock cycle, (e.g. as part of the sample data) if the reorder buffer or pipeline contains one or more instructions, but no instructions are being committed in the clock cycle.

The profiling circuitry may be configured to output a flushed signal, and to write the flushed signal to the sample register or memory, for a processor clock cycle, (e.g. as part of the sample data) if an instruction has triggered a flush of the reorder buffer or pipeline.

The processor and profiling circuitry may, in some embodiments, be implemented as an integrated circuit. The processing system may be an integrated-circuit chip, or it may comprise an integrated-circuit chip that integrates the processor and the profiling circuitry (e.g. with the processing system being a personal computer, server or workstation).

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram showing the architecture of a generic out-of-order processing system;

FIG. 2 is an example of sample data which may be collected by embodiments of the invention described herein;

FIG. 3 is a graph showing a set of exemplary time-proportional Per-Instruction Cycle Stacks which may be created using the information collected by embodiments of the invention described herein;

FIG. 4 is a schematic diagram showing a system which uses dispatch-stage instruction tagging to capture performance events in an out-of-order core, shown for reference purposes only;

FIG. 5 is a schematic diagram showing a system which captures performance events in an out-of-order core at the commit stage in accordance with embodiments of the invention described herein;

FIG. 6 is a schematic diagram showing an implementation of time-proportional event analysis in accordance with embodiments of the invention described herein.

FIG. 7 is a graph showing the percentage error incurred in the collected performance event data by the implementation shown in FIG. 6 when compared to a “golden reference” baseline for each of a set of benchmark processes run on a simulated processor core.

### DETAILED DESCRIPTION

Various example embodiments are described in detail below, and experimental results are then provided which demonstrate the effectiveness of the disclosed approaches.

First, some background is provided to give context for the embodiments described further below, and to demonstrate some of the advantages these embodiments provide over other approaches.

### Background

Software developers can use tools that automatically attribute processor execution time to source code constructs, such as instructions, basic blocks, and functions, in order to improve the efficiency of the software they write.

Hardware-supported profiling enables sampling in-flight instructions without interrupting the application, effectively removing the latency from sampling decision to sample collection. Hardware profilers rely on sampling, which involves collecting and logging instruction addresses at regular time intervals. The theory is that the number of sample counts assigned to a particular instruction over a profiling period indicates how much time the processor spent executing that instruction. Thus, performance profiling in this way can be used to gain insight into which instructions an application spends most time executing, i.e. the performance-critical instructions.

It is also desirable for software developers to determine why these instructions are performance critical. This can be determined by identifying the microarchitectural performance events which occur during an instruction's execution.

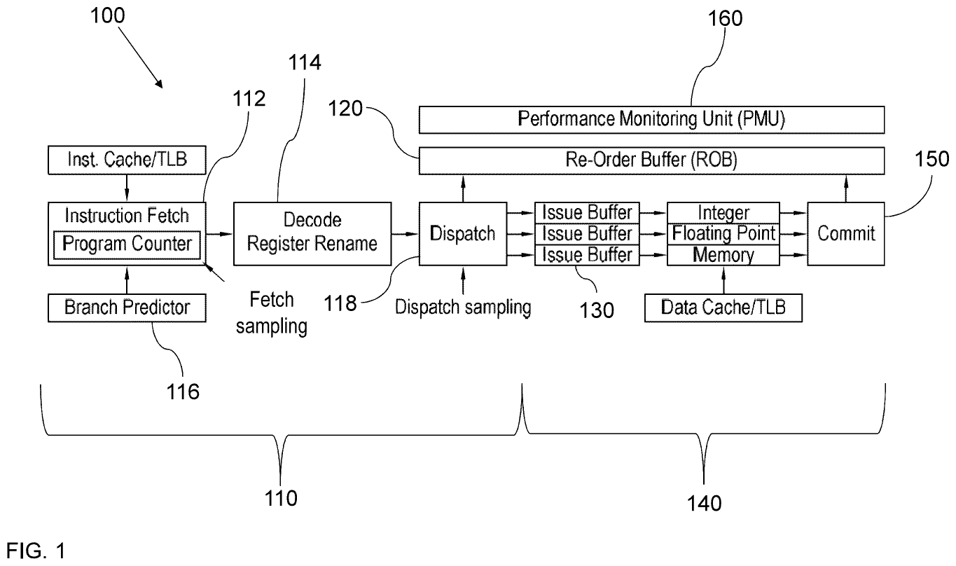

FIG. 1 illustrates the architecture of a generic out-of-order processing system 100. Out-of-order processors have an in-order front-end 110 that has a fetch stage 112 that fetches instructions from system memory, followed by a register rename and instruction decode stage 114, a branch predictor 116, and a dispatch stage 118, which dispatched instructions to the reorder buffer (ROB) 120 and to the issue queues 130 of the appropriate execution units. Then, in the back-end 140 of the processor, instructions are executed as soon as their inputs are available (possibly out-of-order). Instructions are typically committed at the commit stage 150 in program order, and the ROB 120 is used to track instruction order. Performance events can be recorded by the Performance Monitoring Unit (PMU) 160. Performance events which affect the latency of each instruction can occur in the front-end 110 or the back-end 140 of the processor. For example, an instruction cache miss may occur at the fetch stage 112, and a mis-predicted branch may occur when the instruction is in the ROB 120.

There are existing approaches for identifying the microarchitectural performance events which occur during an instruction's execution. Instruction-driven approaches, include those implemented in AMD's Instruction-based sampling (IBS) (see Instruction—Based Sampling: A New Performance Analysis Technique for AMD Family 10h Processors. Technical Report. AMD, Paul J Drongowski. 2007.), Arm's Statistical Profiling Extension (SPE) (ARM Architecture Reference Manual Supplement Statistical Profiling Extension, for ARMv8-A. ttps://static.docs.arm.com/ddi0586/a/DD10586A_Statistical_Profiling Extension.pdf, Arm 2017) and IBM's Random Instruction Sampling (RIS) (see IBM. 2018. POWER9 Performance Monitor Unit User's Guide. https://ibm.ent.box.com/s/8kh0orsr8sg32zb6zmq1d7zz6hud3f8j). These instruction-drive approaches tag individual instructions in the front-end 110, e.g. at the fetch stage 112 or dispatch stage 114, for sampling, and then record the performance events that the tagged individual instruction is subjected to in the PMU 160. Recording these performance events for each sampled instruction means that a statistical picture can be built up of the performance events which occur most often for each instruction. Insight can therefore be gained with regard to what performance events cause the most latency for each sampled instruction.

However, these existing approaches fall short because they do not sample instructions in a time-proportional manner. Tagging the instructions in the pipeline at the fetch 112 or dispatch 114 stages (e.g. as for AMD IBS, Arm SPE and IBM RIS) biases the instruction profile towards sampling instructions that spend a lot of time in the fetch 112 and dispatch 114 stages. As appreciated by the inventors, an instruction's key contribution to execution time is not at the fetch stage 112 or dispatch 114 stage, rather it is the fraction of time it prevents the core from committing instructions. Thus, performance profiling should be carried out by sampling at the commit stage 150, in order to generate a performance profile in which the importance of an instruction is proportional to the instruction's relative contribution to overall execution time.

The inventors have appreciated that the instruction that the CPU is exposing the latency of in a sampled cycle should be determined in dependence on the commit state of the processor. More specifically, the processor will be in one of four commit states in any given cycle:

Compute: The processor is committing one or more instructions. Time-proportionality hence should evenly distribute time across the committing instructions (i.e., 1/n cycles to each instruction when n instructions commit in parallel), by sampling all the instructions which are being committed.

Drained: The ROB 120 is empty because of a front-end stall, for instance due to an instruction cache miss. Time should hence be attributed to the next-committing instruction.

Stalled: An instruction I is stalled at the head of the ROB 120 because it has not yet been fully executed. Time should hence be attributed to I which is the next-committing instruction.

Flushed: An instruction I caused the ROB 120 to flush, for instance due to a mis-predicted branch, and the ROB 120 is empty. Time should hence be attributed to I but unlike in the stall and drain states it has already committed, i.e., I is the last-committed instruction.

The state-of-the-art performance profiler (referred to as TIP herein) proposed by the inventors in TIP: Time-Proportional Instruction Profiling. In Proceedings of the International Symposium on Microarchitecture (MICRO), Association for Computing Machinery, 15-27, 2021 (Björn Gottschall, Lieven Eeckhout, and Magnus Jahre) is time-proportional, on account of applying these sampling principles to the profiling process, in contrast to other performance profilers.

However, sampling at the commit stage 150 (either the next-committing instruction or the last-committed instruction), as carried out in TIP, means that the sampled instruction is only identified after it has been subjected to any performance events which occurred earlier in the execution pipeline (e.g. an instruction missed in the instruction cache at the fetch stage 112). This is in contrast to the existing instruction-driven event analysis approaches which can record the performance events which have occurred as a result of tagging instructions for sampling earlier, at the fetch stage 112 or the dispatch stage 114. Thus, determining what the underlying events causing the latency of each instruction are presents a challenge in combination with sampling in a time-proportional manner.

Nonetheless, the inventors have appreciated that it would provide greater performance insight than either TIP or existing instruction-driven event analysis approaches, if instructions can be sampled using time-proportional principles, and the time the architecture spends executing each instruction can also be broken down into the (combinations of) performance events it encountered during program execution.

### Time-Proportional Event Analysis

The inventors have devised a principle of time-proportional event analysis, as disclosed herein. One family of exemplary processing systems, devised by the inventors, that implement this general principle is referred to herein as “TEA” (short for Time-proportional Event Analysis system), and is described in detail below. The general principle of time-proportional event analysis, however, may also be implemented in other processing systems in ways that differ from the TEA designs described below.

The exemplary TEA embodiments described herein provide hardware support for tracking the performance events that each instruction encounters during its execution, enabling the instructions to be sampled at the commit stage, as well as capturing performance events prior to commit.

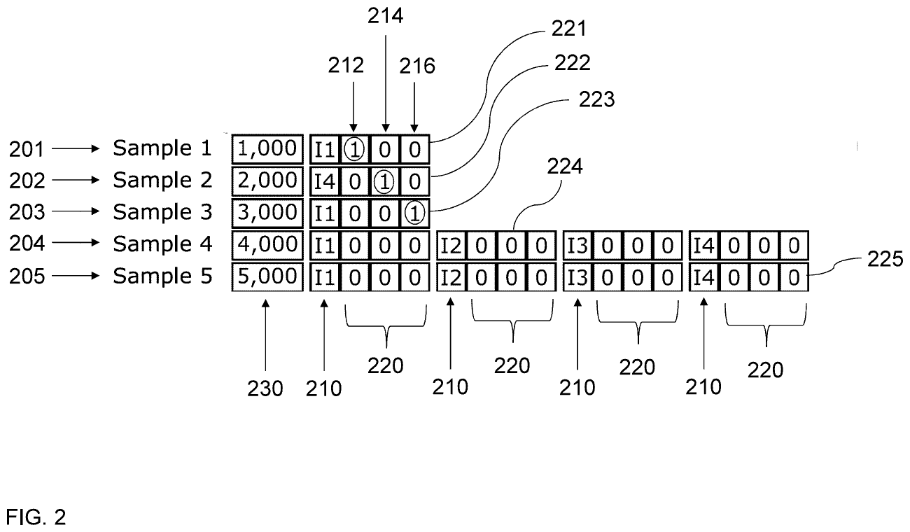

FIG. 2 illustrates an example of the information which TEA can collect when sampling an application executing the short loop of instructions shown below on an out-of-order processor.

| | |
|---|---|
| IX | . . . |
| I1 | lw a4, (a5) |
| I2 | addw a0, a0, a4 |
| I3 | addi a5, a5, 4 |
| I4 | bne a5, a3, I1 |
| IY | . . . |

The processor attaches a Performance Signature Vector (PSV) 220 to each in-flight instruction executed by the processor during execution, but only the PSVs associated with sampled instructions are recorded by the performance monitoring unit. During application execution, TEA uses a cycle counter to periodically sample instructions and collect PSV(s) at a typical 4 kHz frequency.

For each sample (201, 202, 203, 204, 205), TEA identifies the instruction pointer(s) 210 of the instruction(s) which are exposed in the architecture at the sample time, following the time-proportional attribution policies of TIP. TEA also retrieves the PSV 220 associated with each of the sampled instructions. A TEA sample hence consists of a PSV 220 for all sampled instructions in addition to the information returned by TIP (i.e., instruction address(es) 210 and timestamp 230). When the sample is ready, the PMU interrupts the core, and the interrupt handler reads the instruction pointer(s) 210 and PSV(s) 220 and stores them in a memory buffer.

Each PSV 220 includes one bit for each supported performance event. This exemplary implementation shown in FIG. 2 supports tracking and recording three different performance events, with the bits 212, 214 and 216 allocated to recording an instruction cache miss, branch mis-predict, and data cache miss respectively.

In sample 201 shown in FIG. 2, the ROB has drained due to an instruction cache miss when fetching the instruction I1. I1 is therefore sampled, and since I1 was subjected to an instruction cache miss, the instruction cache miss event bit 212 is set in its PSV 221.

In sample 202, the ROB has again emptied, but now the reason is that branch instruction I4 was mis-predicted. I4 hence committed while all younger instructions were squashed, resulting in the processor being in the Flushed state. The sample is therefore attributed to I4, and the branch mis-predict bit 214 of the PSV 222 is set.

In sample 203, I1 is again the cause of performance loss, but this time it is stalled on a cache miss. The processor is therefore in the Stalled state, I1 is sampled, and the data cache miss event bit 216 is set in the PSV 223.

In samples 204 and 205, the working set of I1 has been loaded into the L1 cache and the branch predictor has learned how to predict I4 correctly. The 4-wide core is thus able to commit I1, I2, I3, and I4 in parallel and is in the Compute state. All bit entries in the PSVs retrieved in samples 3 and 4 (e.g. 224, 225) are 0 because none of the instructions were subjected to any performance event.

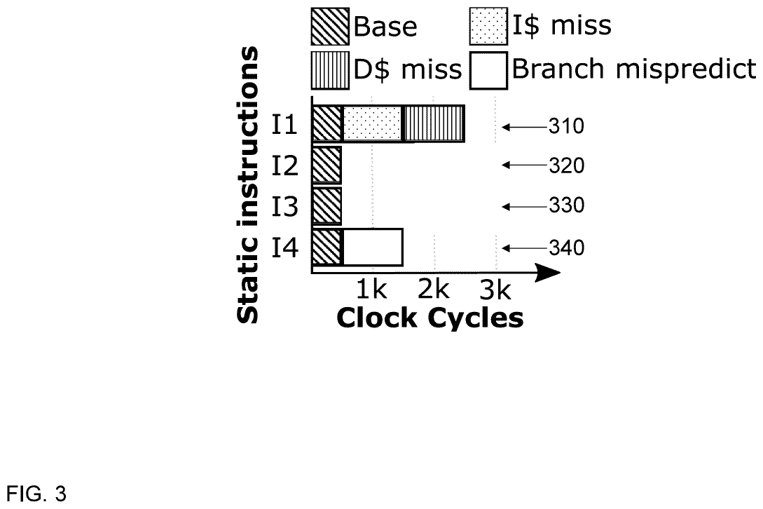

When the application completes, the PSVs 220 which were sampled and stored are post-processed to create per-instruction cycle stacks (PICS) shown in FIG. 3, which aggregate the collected PSVs for each static instruction which was included in the loop set out above.

Cycle stacks 310, 320, 330 and 340 are created for I1, I2, I3, and I4 respectively. Each sample is mapped to static instructions using the address(es) of the instruction(s), and then categorized according to the PSV value—which identifies the (combination of) performance event(s) that caused the processor to expose the latency of this instruction in this sample. From samples 201 and 203, TEA attributes 1,000 cycles to I1 due to the instruction cache miss event, and 1000 cycles to I1 due to a data cache miss event.

Similarly, TEA attributes 1,000 cycles to I4 for the mis-predicted branch in sample 202. The remaining cycles are distributed evenly across I1, I2, I3, and I4 since they commit in parallel in samples 204 and 205. This category is labelled ‘Base’ since none of the instructions were subjected to performance events.

If an instruction is subjected to multiple events, multiple bits are set in the PSV 220. Events that impact the same instruction are referred to as combined events. Combined events are often serviced sequentially, e.g., an instruction cache miss must resolve for a load to be executed and subjected to a data cache miss. The stall cycles caused by this load are hence caused by both events and it is challenging to tease apart the stall impact of each event. TEA hence reports combined events as separate categories. The inventors have found that out of all dynamic instruction executions that encounter at least one event, 30.0% are subjected to combined events. Combined events are hence not too common, but can help to explain challenging issues.

The inventors have appreciated that greater performance insight can be obtained by creating these time-proportional Per-Instruction Cycle Stacks (PICS), in which the time the architecture spends executing each instruction is broken down into the (combinations of) performance events it encountered during program execution. Since the PICS generated using the invention described herein are time-proportional by design, they have the desirable properties that (i) the height of the cycle stack is proportional to a static instruction's impact on overall execution time—hence identifying the performance-critical instructions, and (ii) the size of each component in the cycle stack is proportional to the impact on overall performance that this (combination of) performance event(s) incurs—thus identifying the most frequent causes of the instructions' latency.

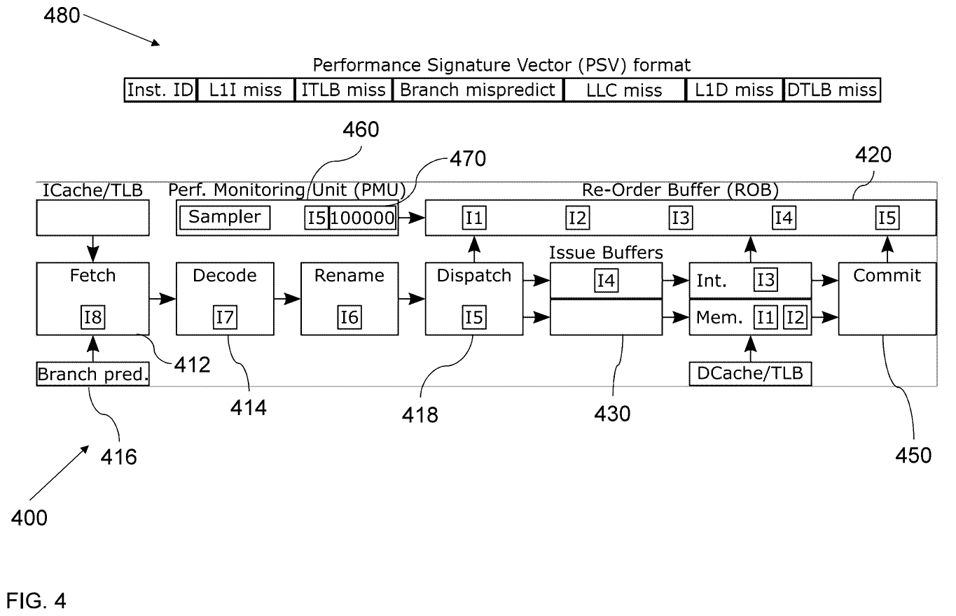

In order to generate this data, the invention proposed herein records the performance events each instruction is subjected to during its execution, i.e., it creates a PSV for each instruction packet. An instruction packet is the instruction, or micro-instruction (μop) itself and its associated metadata (e.g., the instruction address) which the processor updates and forwards as the instruction flows through the pipeline. FIG. 4 illustrates how a system 400 which uses dispatch-stage instruction tagging (e.g. AMD IBS) captures PSVs by showing the execution state of an out-of-order core. In an analogous manner to the conventional out-of-order processing system shown in FIG. 1, the system comprises a fetch stage 412, decode stage 414, branch predictor 416 and a dispatch stage 418 in the front-end of the processor, a re-order buffer 420, issue buffers 430 and a commit stage 450 in the back-end of the processor. Performance events are recorded in a PSV 470 which is stored in the PMU 460. This architecture supports tracking six performance events and hence has a six-bit PSV format 480.

Dispatch-tagging marks the instruction that is dispatched in the cycle the sample is taken, i.e., I5. In the Example shown in FIG. 4, instruction I5 has been subjected an instruction cache miss at the dispatch stage, which is recorded by setting the most significant bit to 1 in the PSV 470. The key benefit of tagging instructions in the front-end is that the scheme only needs to track performance events for the tagged instruction, i.e., it needs one PSV 470 to record the events that the tagged instruction is subjected to, which is stored in the performance monitoring unit 460. Fetch-tagging works in the same way as dispatch tagging, except that it tags at fetch rather than at dispatch and would hence tag I8 in this example.

Tagging at dispatch or fetch does however incur significant error because it is not time-proportional. More specifically, sampling I5 or I8 is not time-proportional because I1 is stalled at the head of the ROB at the time the sample is taken, i.e., the processor is exposing the latency of I1 in this cycle. This situation is common because performance-critical instructions tend to stall at commit which in turn stalls the front-end—resulting in the PSVs of the instructions that are dispatched or fetched during stalls being overrepresented in the performance data which is collected. Tagging at dispatch or fetch also captures events that may not impact performance. For example, I1 is stalled on a combined data cache and TLB miss event, but dispatch-tagging captures I5's instruction cache miss (which is hidden under I1's events).

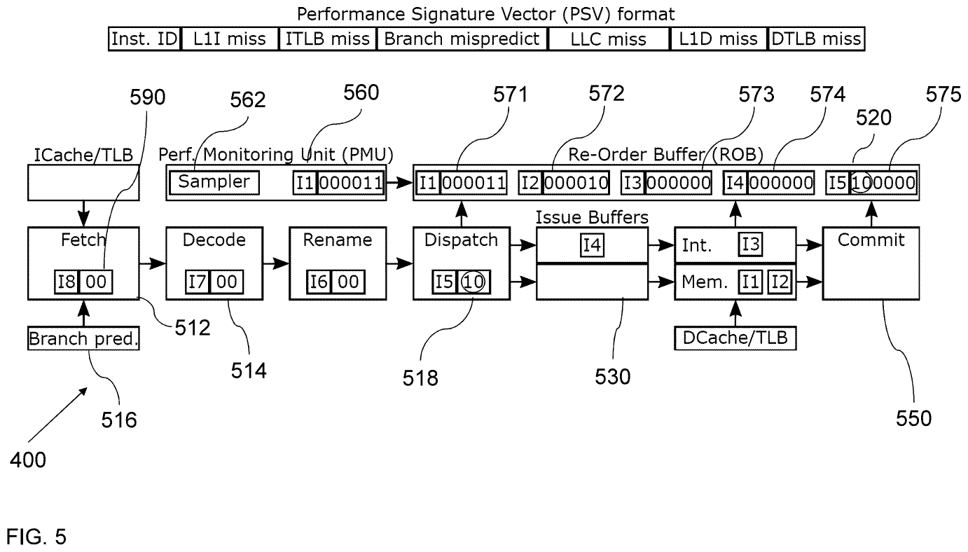

FIG. 5 illustrates how TEA, in accordance with embodiments of the invention described herein, would captures PSVs for the same performance-events, and the same core state as shown in FIG. 4. In an analogous manner to the processing system shown in FIG. 4, the system comprises a fetch stage 512, a decode stage 514, a branch predictor 516 and a dispatch stage 518 in the front-end of the processor, a re-order buffer 520, issue buffers 530 and a commit stage 550 in the back-end of the processor.

A six-bit PSV, e.g. 501, 502, 503, 504, 505, is initialised at the dispatch stage 518 for each entry into the re-order buffer (ROB) 520. The six-bit PSVs are then stored in the ROB 520 alongside their respective associated instruction packets. Any performance events which the instruction is subjected to after the dispatch stage 518 can be recorded by setting the corresponding bit of the PSV in the ROB. The PSV(s) are recorded in the PMU 560 when the instruction is sampled from the ROB 520.

Some performance events may occur in the front-end, before the affected instruction packet reaches the ROB 520. Any performance events that occur along the pipeline stages before the full six-bit PSV e.g. 501, 502, 503, 504, 505 is initialised at the dispatch stage 518 therefore need to be recorded and passed along the pipeline. In the example shown in FIG. 5, the supported performance events that can occur before or at dispatch are an instruction cache miss (L1I miss) and a translation lookaside buffer (TLB) miss (ITLB miss). These two events are recorded at the stage where they occur, and passed along the pipeline to the dispatch stage 518. The six-bit PSV associated with each ROB entry is therefore initialised at the dispatch stage 518 by setting the front-end bits of the PSV to their respective recorded values from the earlier pipeline stages, and all remaining PSV-bits to zero. Two bits of hardware storage 590 are added to each pipeline stage up to and including dispatch 518 so that these events can be captured when they occur.

In the example shown in FIG. 5, instruction I5 has been subjected an instruction cache miss at the dispatch stage, which is recorded by setting the most significant bit to 1. This is copied across into the PSV 575 when it is initialised, and stored in the ROB 520 alongside the instruction packet for instruction I5.

I2 has also been subjected to a data cache miss at some point earlier in the pipeline, reflected in the second least-significant bit of its associated PSV 572, while the PSVs 573 and 574 for I3 and I4 respectively are all zeros because they so far have not been subjected to any performance events.

The Sampler 562 in the PMU 560 accesses the ROB 520 to retrieve the address of the last-committed instruction(s), or next-committing instruction(s) according to time-proportional sampling principals, along with the associated PSVs when sampling. For the example shown in FIG. 5, I1 is the oldest instruction and has stalled due to an L1 cache miss and a TLB miss which occurred earlier in the pipeline. The two least significant bits of its PSV 571 are hence both 1. Since TEA operates using time-proportional sampling, the hardware sampler selects I1 (the next-committing instruction) and its PSV 571 before interrupting the processor such that the software sampling function can retrieve the sample and store it in a memory buffer.

The details of a particular preferred embodiment of time-proportional event analysis (TEA) are now explained below. While this particular embodiment is designed for an open-source Berkeley Out-of-Order Machine (BOOM) core (Sonic-BOOM: The 3rd Generation Berkeley Out-of-Order Machine. Fourth Workshop on Computer Architecture Research with RISC-V, Jerry Zhao, Ben Korpan, Abraham Gonzalez, and Krste Asanovic. 2020), the approach will be similar for other microarchitectures, i.e., some implementation details will be different but the flow of information will remain the same.

### Performance Event Hierarchies

TEA tracks performance events for all in-flight instructions, so it is beneficial to carefully select a small set of performance events that collectively capture key architectural bottlenecks to keep overheads in check.

Fortunately, performance events can be grouped according to the non-compute commit state they can cause. Performance events also form hierarchies can be exploited to trade off overhead against interpretability, i.e., the ability of the selected set of performance counters to explain the cause of the time delay.

The inventors have hence appreciated that event hierarchy can be exploited to balance how easy it is for a developer to interpret the collected performance data—which favours capturing more events and thereby explaining increasingly complex architectural behaviours—against overheads, which favours selecting a smaller set of performance events to track.

Performance events can be dependent or independent. Dependent performance events can only occur if a prior performance event has occurred. For example, for a stalled commit state, a load can only miss in the LLC if it has already missed in the L1 cache. Independent performance events in contrast occur independently of each other, e.g., a load can hit in the L1 cache independently of it hitting or missing in the L1 TLB.

When selecting a set of events to track for a stalled commit state, a single-bit PSV could be implemented which only captures that a load stall occurred. This has a low overhead, but offers limited insight. Interpretability can be improved by moving to a 2-bit PSV. In this case, the most favourable option is to include L1 data cache and TLB miss events, as they cover all possible events which could lead to a load stall. Interpretability can be improved further still by adding dependent events of the L1 data and TLB misses (i.e. an LLC miss and an L2 data TLB miss). In this case, the root event of each dependency chain, i.e. the L1 data cache miss and L1 data TLB miss, would still need to be reported to avoid losing interpretability. For example, if LLC misses were captured, but not L1 misses, LLC hits would not be identifiable.

Table 1 lists the nine performance events that are captured in the exemplary preferred implementation of TEA described herein.

TABLE 1
The performance events of TEA, IBS, SPE, and RIS.

| Event | Description | TEA | IBS | SPE | RIS |
|---|---|---|---|---|---|
| DR-L1 | L1 instruction cache miss | ✓ | ✓ | X | ✓ |
| DR-TLB | L1 instruction TLB miss | ✓ | ✓ | X | ✓ |
| DR-SQ | Store instruction stalled at | ✓ | X | X | ✓ |
| | dispatch | | | | |
| FL-MB | Mis-predicted branch | ✓ | ✓ | ✓ | ✓ |
| FL-EX | Instruction caused exception | ✓ | X | ✓ | X |
| FL-MO | Memory ordering violation | ✓ | X | X | X |
| ST-L1 | L1 data cache miss | ✓ | ✓ | ✓ | ✓ |
| ST-TLB | L1 data TLB miss | ✓ | ✓ | ✓ | ✓ |
| ST-LLC | LLC miss caused by a load | ✓ | ✓ | ✓ | ✓ |
| | instruction | | | | |

The performance events are named with the form X-Y, where X is the commit state and Y is the event, e.g., an L1 data cache miss is labelled ST-L1, since it explains the Stalled commit state.

To explain the Drained state, an instruction missed in the L1 instruction cache is captured by the event DR-L1, an instruction missed in the L1 instruction TLB is captured by the event DR-TLB, and the ROB draining due to a full store queue is captured by the event DR-SQ. The DR-SQ event occurs where the ROB drains because a store cannot dispatch, on account of the Load/Store Queue (LSQ) being full of completed but not yet retired stores. Including this event improves interpretability when the application is sensitive to store bandwidth.

For the Flushed state, a mis-predicted branch is captured by the event FL-MB, an exception is captured by the event FL-EX, and a memory ordering violation is captured by the event FL-MO. A memory ordering violation occurs when a load executes before an older store to the same address, and hence has read stale data. It is addressed by re-executing the load and squashing all younger in-flight instructions (which is time-consuming).

To explain the Stalled state, an L1 data cache miss is captured by event ST-L1, an L1 data TLB miss is captured by the event ST-TLB, and an LLC miss caused by load instructions is captured by the event ST-LLC. Capturing LLC misses improves interpretability for memory-sensitive applications.

Table 1 also shows the events captured by the instruction-driven approaches AMD IBS, Arm SPE, and IBM RIS. These approaches capture many of the same events as TEA, although some differ.

### TEA Microarchitecture

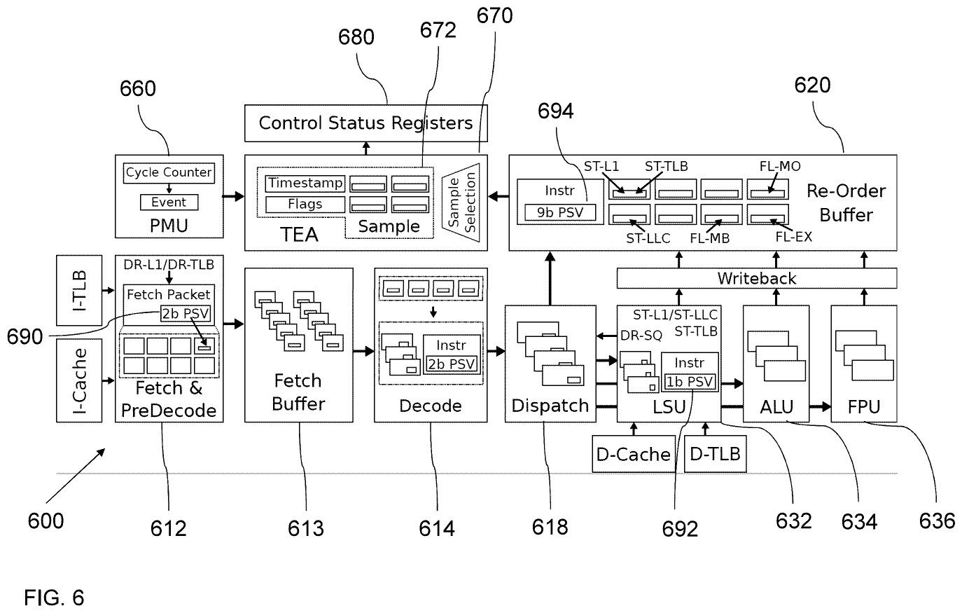

FIG. 6 illustrates the proposed exemplary implementation of TEA in a BOOM core 600. The BOOM core operates in a similar manner to the generic out-of-order core described with reference to FIG. 1.

The system 600 comprises a fetch stage 612 configured to output instruction packets to a fetch buffer 613, a decode stage 614, a branch prediction module 616 and a dispatch stage 618 in the front-end of the processor. The system also has a re-order buffer 620, a commit stage 450 and functional units including a Load-Store Unit (LSU) 632, an Arithmetic Logic Unit (ALU) 634 and a Floating-Point unit (FPU) 636. Sampling is triggered by the Performance Monitoring Unit 660 and sampling is carried out by the sampling unit 670, then output via the Control Status Registers (CSRs) 680. This architecture supports the nine performance events described in Table 1 above, and hence has a nine-bit PSV format.

As discussed above, the proposed implementation of TEA tracks PSVs across all inflight instructions. Storage bits are therefore added to different stages of the pipeline to track the PSVs.

The DR-L1 and DR-TLB events occur in the fetch stage 612. A 2-bit PSV 690 is therefore allocated for the fetch packet. Because the DR-L1 and DR-TLB events are always incurred by the first instruction of the fetch packet, only a single PSV is required for all instructions in the fetch packet. When the fetch packet is expanded into individual instructions and added to the fetch buffer 613, the 2-bit fetch packet PSV 690 is copied into the PSV of the first individual instruction, and the PSVs of all other instructions are initialized to zero.

In the decode stage 614, the instructions from the fetch buffer 613 are decoded into micro-operations (pops) and a PSV for each pop is passed along the pipeline. Some architectures may perform pop fusion at the decode stage 614, in which a set of multiple pops may sometimes be fused into a single pop for dispatch. Some architectures may have the capability to perfom pop fusion at any point in the pipeline after the decode stage 614. The fused pops may be generated from several pops associated with the same instruction, or may also be generated from pops associated with two of more different static instructions. In such architectures, a PSV associated with each fused pop is passed along the pipeline, which aggregates the PSVs stored for each static instruction from which the fused pop was derived into a single PSV. The dispatch stage 618 inserts pops (which could include individual pop or fused pops) into the ROB 620 and the issue queues of the functional units (the LSU 632, the ALU 634 and the FPU 636). The dispatch stage 618 detects the DR-SQ event when a store is the oldest pop and cannot dispatch due to a full Load-Store Queue (LSQ).

To avoid complicating the LSU-to-ROB interface, a single bit of storage 692 is allocated in each LSU entry for an ST-TLB event because it is detected before the cache responds. ST-L1 and ST-LLC events in contrast become available upon a cache response and can hence be communicated immediately to the ROB 620 (through Writeback).

The complete 9-bit PSV (e.g. 694) of each pop is stored in the pop's ROB-entry. The FL-MB, FL-EX, and FL-MO events are already detected by the ROB 620 because they require flushing the pipeline, and the ROB 620 can hence record them in the PSV directly.

The sampling unit 670 is connected to the head of the ROB 620 with the time-proportional sample selection logic inherited from TIP. Once a cycle counter event is emitted by the PMU 660, the sampling unit 670 identifies the commit state of the processor 660 (i.e., Computing, Stalled, Flushed, or Drained), and selects the appropriate pop(s) for sampling in dependence on the state. The sampling unit 670 delays returning the sample if the processor is either Stalled or Drained until the next pop commits to ensure that the next-committing pop's PSV is updated.

When a single static instruction is mapped to more than one pop, TEA attributes time to the static instruction by aggregating across the pops in the sample that belongs to the instruction. As set out above, some architectures perform pop fusion in which multiple pops are fused into a single pop transparently in hardware. If the individual pops within the fused pop are all derived from the same static instruction, TEA attributes time to the fused pop according to the commit state of the processor and merges any performance events the pops have been subjected to. TEA handles fused pops derived from two or more different static instructions as a special case of the Computing state. A fused pop will (i) commit in a single cycle, and (ii) be subjected to the same performance events. TEA hence attributes time to the static instructions proportionally to the number of pops from each static instruction and copies the PSV. For example, if two pops from a static instruction A are fused with two pops from a static instruction B to form a single fused pop, and the processor is stalled on the fused pop when the sample is taken, TEA attributes half of the sample to A and half to B. If the fused pop were subjected to an LLC miss (i.e., an ST-LLC event), TEA would set the ST-LLC bit for both static instructions.

A sample 672 retrieved by the sampling unit 670 contains a timestamp, flags (i.e., commit state and valid bits) as well as the static instruction address(es) and PSV(s). the proposed implementation of TEA is indifferent to tracking pops or dynamic instructions since it in both cases maps them to static instructions when sampling. Finally, the sample is written to the Control and Status Registers (CSRs) 680 and an interrupt is issued.

The interrupt causes the sampling software to retrieve TEA's sample 672 as well as inspect other CSRs to determine the logical core identifier and process and thread identifiers before writing all of this information to a buffer in memory (which is flushed to a file when necessary). This is the typical operation of Linux perf (a performance analysing tool in Linux). A logical core identifier maps to a hardware thread under Simultaneous Multi-Threading (SMT) and a physical core otherwise. One TEA sampling unit is required per physical core. While single-threaded applications have been described herein, the proposed concept of TEA is equally applicable to multi-threaded applications.

The ability of profiling tools to map samples to processes also enables generating performance data for any piece of software (e.g., operating system code and just-in-time compilers).

All collected samples are available in a file when the application terminates. This sample file may then be supplied as input to a software tool which aggregates cycles across the PSV signatures of each static instruction, thereby creating per-instruction cycle stacks (PICS), as explained with reference to FIG. 3, for each static instruction. Each category in the PICS corresponds to a specific (combination) of performance event(s). A developer can then use this tool to analyse application performance by visualizing PICS at various granularities (e.g., static instructions and functions).

### TEA Overheads

Determining the commit state of the processor to carry out time-proportional sampling of instructions as proposed by the inventors previously in TIP, firstly incurs a storage overhead of 57 B compared to an unmodified BOOM core.

To track PSVs across all inflight instructions, the following modifications are made: Two bits per entry in the 48-entry fetch buffer 613 are added to store the DR-L1 and DR-TLB events (12 B); and a 9-bit PSV field is added to each ROB entry (216 B for the 192-entry ROB used in the exemplary implementation described hereinabove); three 2-bit registers are added in the fetch stage 612 to track DR-L1 and DR-TLB for all fetch packets; and 2 bits for each entry in the decode stage 614 and the dispatch stage 618 to track these events through the rest of the front-end; a one-bit register is added to the dispatch stage 618 to track the DR-SQ event and one bit in each LSU entry is added to track ST-TLB until the load completes. A register for the PSV of the last-committed instruction is also handled, so that the Flushed state can be correctly handled by sampling the LCI. The overall storage overhead of TEA is hence 249 B per core (and 306 B per core for TEA and TIP).

Since the prior-art systems of IBS, SPE, and RIS tag instructions in the front-end, they know which instruction to capture PSVs from and hence only require storing 6, 5, and 7 bits, respectively, i.e., one byte. They do however capture other information such as branch targets, memory addresses, and various latencies when implemented in commercial cores. The minimum storage requirements of IBS, SPE, and RIS are hence negligible, but this benefit is due to tagging instructions in the front-end which is also the root cause of their large errors.

To better understand the power overhead of TEA (and TIP), the ROB and fetch buffer modules of the BOOM core were synthesised in a commercially available 28 nm technology with and without TEA using Cadence Genus and estimated its power consumption with Cadence Joules. The ROB and fetch buffer were the focus of the analysis because they account for 91.7% of TEA's storage overhead.

Overall, TEA increases the power consumption of these units by 4.6%. In absolute terms, supporting TEA in these units increases power consumption by 3.2 mW which is negligible. For example, RAPL (see RAPL: Memory Power Estimation and Capping. In Proceedings of the International Symposium on Low Power Electronics and Design (ISLPED). Association for Computing Machinery, 189-194, Howard David, Eugene Gorbatov, Ulf R. Hanebutte, Rahul Khanna, and Christian Le, 2010) reports a core power consumption of 32.7 W on a recent laptop with an Intel i7-1260P chip running stress-ng on all 8 physical cores which yield 4.7 W per core. Implementing TEA on this system would hence increase per-core power consumption by ˜0.1%. If this power overhead is a concern, the PSVs can be clock or power-gated and enabled ahead of time such that the PSVs for all in-flight instructions are updated when sampling.

TEA's performance overhead is the same as TIP because the PSVs can be packed into the CSR that TIP uses to communicate sample metadata to software. A CSR must be 64 bit wide to match the width of the other registers in the architecture, but TIP only uses 10 bits for metadata. Communicating four PSVs requires 36 bits which result in TEA using 46 out of 64 CSR bits. TEA hence retains the 88 B sample size from TIP which results in a performance overhead of 1.1%. TEA's logic is not on any critical path of the BOOM core, and TEA hence does not impact cycle time.

### TEA Event Selection Performance

As described above, the proposed implementation of TEA exploits event hierarchies to select a set of events to record in the PSVs which balance interpretability and overhead. Interpretability is most important for the stall events which cause the longest delays.

The proposed approach described in detail herein was compared to a “golden reference” baseline. This baseline computes event performance data for every dynamic instruction, i.e., we know for each dynamic instruction how it contributes to the total execution time and which performance events it is subjected to. This is clearly impractical to implement in a real system because it would require communicating the PSVs to software for every dynamically executed instruction which would incur a prohibitively high performance-overhead. More specifically, the golden reference requires communicating and parsing 2.7 petabytes of performance data in total at a rate of 116 GB/s. This golden reference is nevertheless extremely useful because it represents the ideal performance profile to compare against.

Out of all the instructions that stalled the commit stage as determined by the golden reference, the inventors found that 99% of the instructions which were not identified by the proposed set of events in the PSVs caused a stall which was shorter than 5.8 clock cycles. Thus, the proposed set of events for the example implementation of TEA captured the events that can majorly impact performance.

### TEA Performance Data Accuracy

To compare the accuracy of the state-of-the-art approaches for generating event-level performance data to the proposed TEA approach, a BOOM 4-way superscalar out-of-order core was simulated using a cycle-accurate FPGA-accelerated full-system simulator, and a broad set of SPEC CPU 2017 benchmark applications were run that are compatible with the experimental setup.

Results for both the state-of-the-art approaches and the proposed TEA approach were compared to the “golden reference” baseline described above.

The state-of-the-art approaches for creating Per-Instruction Cycle Stacks (PICS) are represented by IBS, SPE, and RIS which are our best-effort implementations of AMD IBS, Arm SPE, and IBM RIS. IBS and SPE tags instructions at dispatch whereas RIS tags instructions while forming instruction groups in the fetch stage. IBS, SPE, and RIS all record the performance events that tagged instructions are subjected to while they travel through the pipeline but support different event sets (see Table 1 presented earlier).

Two variants of TEA are used in the comparison. NCI-TEA combines the events supported by TEA with a Next-Committing Instruction (NCI) sampling policy which has been shown to be significantly more accurate than tagging instructions at fetch or dispatch. TEA is the approach proposed in accordance with the invention as described hereinabove which uses time-proportional PSV sampling. Instructions are typically sampled at a frequency of 4 kHz for all techniques, unless mentioned otherwise.

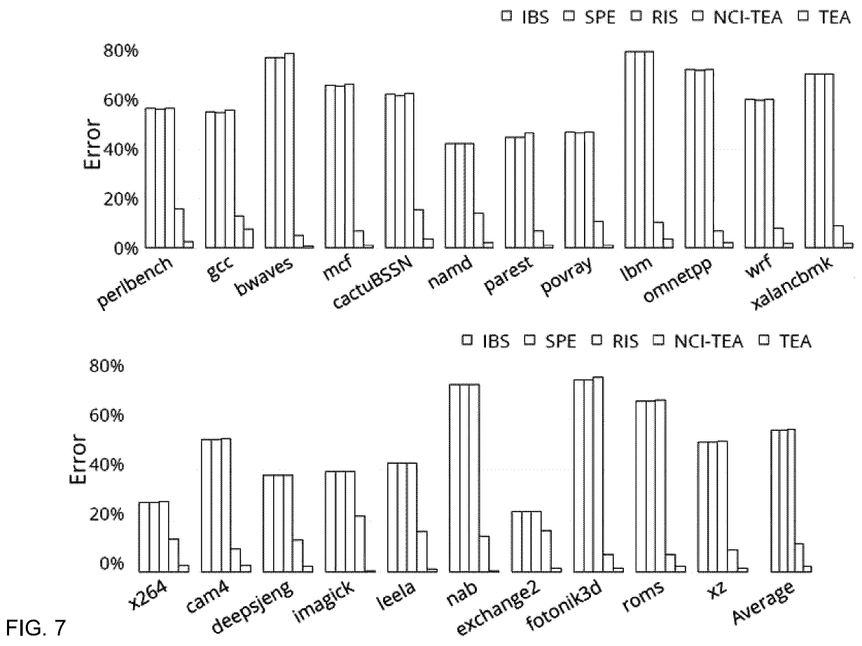

FIG. 7 shows the percentage error incurred in the collected performance event data when compared to the golden reference baseline for each benchmark process run on the simulated core. The results for each benchmark, shown left-to right, are for IBS, SPE, RIS, NCI-TEA and TEA.

A few interesting observations can be made. Firstly, IBS, SPE, and RIS are significantly less accurate than NCI-TEA and TEA. The reason is that IBS, SPE, and RIS tag instructions at dispatch or fetch which leads to non-time-proportional performance profiles. This confirms the observation from prior work on TIP.

Secondly, sampling instructions at commit substantially improves accuracy as is evident from comparing NCI-TEA versus IBS, SPE, and RIS. NCI-TEA samples the instructions as they contribute to execution time, i.e., an instruction that stalls commit has a higher likelihood of being sampled, and, as a result, the cycle stack is more representative of the contribution of this instruction to the program's overall execution time.

Thirdly, sampling at commit is not a sufficient condition for obtaining accurate cycle stacks. The cycle stacks are most accurate if the sample is attributed to the correct instruction, and if the sample is be attributed to the correct signature. Attributing the sample to the next-committing instruction (NCI) is inaccurate in case of a pipeline flush due to a mis-predicted branch or an exception as discussed above. The instruction which is to blame is not the next-committing instruction but the instruction that was last committed, namely the mis-predicted branch or the excepting instruction. TEA solves this issue by keeping track of the PSV of the last-committing instruction as previously described.

Overall, TEA achieves an average error of 2.1% (and at most 7.7%). This is significantly more accurate compared to the other techniques: NCI-TEA (11.3% average error and up to 22.0%), RIS (56.0% average error and up to 79.7%), IBS (55.6% average error and up to 79.7%), and SPE (55.5% average error and up to 79.7%).

Whilst the specific embodiment evaluated herein tracks nine different events in the PSVs, it should be appreciated that any number of events could have been selected to be tracked. The events which provide the best insight into the performance of the processor may vary in dependence on the type of core used, or the program running on the core. The overall principle of collecting performance-event data for sampling at the commit stage, and sampling either the next-committing instruction or last-committed instruction in dependence on the commit state of the processor provide an event-level profiling tool which is significantly more accurate compared to other known approaches. Analysis of the generated performance-event data can then be used by a developer of a software program to create an improved version of the software program (i.e. a more efficient version) for execution by the processor or by a similar processor.

It will be appreciated by those skilled in the art that the invention has been illustrated by describing one or more specific embodiments thereof, but is not limited to these embodiments; many variations and modifications are possible, within the scope of the accompanying claims.

1. A processing system comprising:
a processor; and
profiling circuitry,
wherein the processor is configured to commit instructions in a program order, and comprises circuitry for determining and storing performance-event data for each instruction committed by the processor, wherein the performance-event data for each instruction indicates whether the instruction experiences any of a predetermined set of one or more performance events; and
wherein the profiling circuitry is configured to generate sample data at intervals, and to write the sample data to a sample register or memory, wherein the sample data generated at each interval identifies one or more instructions that are next-to-be committed by the processor or one or more instructions that were last committed by the processor, and comprises the respective performance-event data for each of the identified instructions.

2. The processing system of claim 1, wherein the one or more performance events in the predetermined set are respective micro-architectural events that occur in the pipeline of the processor and slow down the running of the processor.

3. The processing system of claim 1, wherein the processor comprises a front-end and a back-end, and wherein the predetermined set of one or more performance events comprises at least one event that occurs in the front-end of the processor and at least one event that occurs in the back-end of the processor.

4. The processing system of claim 1, wherein the predetermined set of one or more performance events comprises any one or more, or all, of the following performance events: an instruction cache miss, an instruction translation look-aside buffer (TLB) miss, a store instruction stalled at dispatch, a mis-predicted branch, an instruction caused except, a memory ordering violation, a data cache miss, a data TLB miss, and a last-level cache (LLC) miss caused by a load instruction.

5. The processing system of claim 1, wherein the performance-event data for each instruction comprises a respective performance-event vector, wherein the performance-event vector comprises one or more bits of information, wherein each bit in the vector indicates whether the instruction has experienced a different respective performance event from the predetermined set of performance events.

6. The processing system of claim 1, wherein the processor is configured for executing software programs comprising static instructions and is configured to decode each static instruction into one or more dynamic instructions, and wherein, for each dynamic instruction committed by the processor, the processor is configured to store data identifying one or more respective static instructions from which the dynamic instruction was derived.

7. The processing system of claim 6, wherein the processor supports execution of instructions out of program order and comprises a reorder buffer, and wherein the processor is configured, for each dynamic instruction committed by the processor, to store in the reorder buffer the performance-event data and the data identifying the respective one or more static instructions from which the dynamic instruction was derived.

8. The processing system of claim 1, comprising state-determining circuitry configured to access information stored by the processor for committing instructions in program order, and to use the information to determine which of a computing state, a stalled state, a drained state and a flushed state the processor is in; and wherein the profiling circuitry is configured, when the processor is in the computing state, the drained state, or the stalled state, to generate sample data that identifies one or more instructions that are next to be committed by the processor, and, when the processor is in the flushed state, to generate sample data that identifies an instruction that was last committed by the processor.

9. The processing system of claim 8, wherein the state-determining circuitry is configured to write state data to the sample register or memory that is representative of the determined state.

10. The processing system of claim 8, wherein the profiling circuitry is configured, when the processor is in the computing state and will commit a plurality of instructions at the next commit cycle, to write sample data to the sample register or memory that identifies every instruction that is to be committed by the processor in the next commit cycle and that comprises the respective performance-event data for each of the identified instructions.

11. The processing system of claim 1, wherein the intervals at which the profiling circuitry is configured to generate sample data are regular sampling intervals.

12. The processing system of claim 1, wherein the profiling circuitry comprises sampling circuitry, and wherein the sampling circuitry is configured to write sample data to the sample register or memory in response to receiving a command from outside the sampling circuitry.

13. The processing system of claim 1, comprising a memory storing profiling software, wherein the profiling software comprises instructions for processing at least some of the sample data to generate either or both of an instruction-level profile and a performance-event-level profile of a software program executed by the processor.

14. A method for profiling execution of a processor, the method comprising:
determining and storing performance-event data for each instruction committed by the processor, wherein the performance-event data for each instruction indicates whether the instruction experiences any of a predetermined set of one or more performance events; and
generating sample data at intervals, and writing the sample data to a sample register or memory, wherein the sample data generated at each interval identifies one or more instructions that are next-to-be committed by the processor or one or more instructions that were last committed by the processor, and comprises the respective performance-event data for each of the identified instructions.

15. A method of developing a software program comprising:
executing a version of the software program on a processing system according to claim 1 to obtain sample data in the sample register or memory of the processing system;
processing at least some of the sample data to generate either or both of an instruction-level profile and a performance-event-level profile of the software program executed by the processor; and
using either or both of the instruction-level profile and the performance-event-level profile to create an improved version of the software program.
